(19) United States
(12) Patent Application Publication
(10) Pub. No.: US 2017/0059110 A1
(43) Pub. Date: Mar. 2, 2017

(54) LIGHTING AND/OR SIGNALING DEVICE FOR AN AUTOMOTIVE VEHICLE

(71) Applicant: Valeo Vision, Bobigny Cedex (FR)

(72) Inventors: Benoit Reiss, Magency (FR); Pierre Albou, Paris (FR); Etienne Pauty, Bagnolet (FR); Vanesa Sanchez, Bois Colombes (FR); Antoine de Lamberterie, Paris (FR); Gilles Le-Calvez, Rueil Malmaison (FR)

(21) Appl. No.: 15/229,311

(22) Filed: Aug. 5, 2016

(30) Foreign Application Priority Data
Aug. 7, 2015 (FR) 1557617

(51) Int. Cl. F21S 8/10

(52) U.S. Cl. CPC F21S 48/1747; F21S 48/1159; F21S 48/1195; F21S 48/13

(57) ABSTRACT

A lighting device for an automotive vehicle comprising at least two semiconductor light sources that can be selectively activated and at least one optic for shaping at least a portion of the light rays emitted by either or both of the light sources with the aim of generating at least two lighting and/or signaling functions. The device is configured so that a first function requires the activation of the first semiconductor light source and a second function requires the activation of the second semiconductor light source. At least one of the light sources is a semiconductor light-source comprising a light-emitting rods.

### CROSS-REFERENCE TO RELATED APPLICATIONS

This application claims priority to the French application 1557617, filed Aug. 7, 2015, which application is incorporated herein by reference and made a part hereof.

### BACKGROUND OF THE INVENTION

1. Field of the Invention

The invention pertains to the field of interior and/or exterior lighting, and/or of signaling, in particular for automotive vehicles. It more particularly relates to a device that is capable of generating two separate lighting and/or signaling functions via the selective activation of two light sources.

2. Description of the Related Art

An automotive vehicle is equipped with headlamps, or headlights, that are intended to illuminate the road in front of the vehicle at night or in the event of reduced light. These headlamps may generally be used in two lighting modes: a first “high beam” mode and a second “low beam” mode. The “high beam” mode allows the road far in front of the vehicle to be brightly lit. The “low beam” mode provides a more limited lighting of the road, but nonetheless offers good visibility without dazzling other road users. These two lighting modes are complementary and the driver switches from one to the other depending on driving conditions. Switching from one mode to the other may be done manually, the driver deciding on the moment of this switch, or it may be done automatically, depending on the detection, by suitable means, of conditions requiring such a change of lighting mode. Each lighting function may be provided by a module, and the different modules are positioned side by side in the headlamp. However, in particular for reasons of visual comfort of the driver, production cost and esthetics, the manufacturers wish to propose headlamps in which one module is able to alternately carry out either of the functions, so that the corresponding light beam exits via the same optical output face. It is understood that this issue applies regardless of the combination of lighting functions desired to be put in place.

Additionally, in lighting devices for automotive vehicles, the light sources are increasingly frequently composed of light-emitting diodes, in particular because of advantages in terms of footprint and autonomy with respect to conventional light sources. The use of light-emitting diodes in lighting modules has furthermore allowed market players (automobile manufacturers and lighting designers) to add a creative touch to the design of these devices, in particular by using an ever greater number of these light-emitting diodes to achieve optical effects. One of the drawbacks of using these diodes is their production cost.

In these twin contexts, it is known practice to combine either a light-emitting diode (LED) comprising two emitters (double-chip LED) in which each emitter can be addressed individually, or two separate light-emitting diodes that are positioned in proximity to one another.

In both cases, a non-negligible separation between the two emitters is envisaged, this separation possibly representing, for example, 8 to 12% of the size of the chip, which may translate into an angular separation between the low and high beams.

In these twin contexts, a subject of the invention is a lighting device for an automotive vehicle, comprising at least two semiconductor light sources that can be selectively activated and at least one optic for shaping at least a portion of the light rays emitted by either or both of the light sources with the aim of generating at least two lighting and/or signaling functions.

The term “lighting device” is understood equally to mean an interior lighting device, an exterior lighting device, a signaling device or a device that is able to combine exterior lighting and signaling. Additionally, the term “shaping optic” is understood to refer to means allowing the direction of at least a portion of the light rays to be changed.

### SUMMARY OF THE INVENTION

According to one aspect of the invention, the device is configured so that a first function requires the activation of the first semiconductor light source and a second function requires the activation of the second semiconductor light source, at least one of the selectively activatable semiconductor light sources being a semiconductor light source comprising light-emitting rods of submillimeter size.

According to one aspect of the invention, a technology consisting of producing the light-emitting area with a forest of submillimeter-sized light-emitting rods that are grown on a substrate, in order to produce a three-dimensional topology, is applied to the automotive field. It is understood that this three-dimensional topology has the advantage of multiplying the light-emitting surface area with respect to the light-emitting diodes currently known in the automotive field, namely substantially planar diodes. In this way, it is possible, based on two separate sources and a single reflector and by using a source comprising submillimeter-sized light-emitting rods as at least one of these two light sources, to generate a dual lighting function, the use of at least one light source comprising light-emitting rods allowing a specific area to be provided for the creation of a high beam, whose luminance is higher than the luminance of a specific area for the creation of a low beam.

According to different aspects of the invention, it is envisaged that:
the second lighting and/or signaling function solely requires the activation of the second semiconductor light source; in this case, the second lighting and/or signaling function may consist of the formation of a light beam of fog beam type, or else the formation of a light beam of low beam type.
the second lighting and/or signaling function requires the simultaneous activation of the first semiconductor light source and the second semiconductor light source; in this case, it is possible to envisage that the second lighting and/or signaling function consists of the formation of a light beam of high beam type, and that the first lighting and/or signaling function consists of the formation of a light beam of low beam type.

The light-emitting rods may extend from one and the same substrate, and they may in particular be formed directly on this substrate. It is possible to envisage that the substrate is based on silicon or silicon carbide. It is understood that the substrate is silicon based when a majority thereof is composed of silicon, e.g. at least 50% and in practice about 99%.

According to features intrinsic to the makeup of the light-emitting rods and to the positioning of these light-emitting rods on the substrate, it is possible to envisage that, each feature being able to be taken individually or in combination with the others:
each rod takes the general form of a cylinder, in particular with a polygonal cross section; it is possible to envisage that each rod takes the same general form, and in particular a hexagonal form;
the rods are each delimited by a terminal face and a circumferential wall that extends along a longitudinal axis of the rod, defining the height thereof, the light being emitted at least from the circumferential wall; this light could also be emitted by the terminal face;
the terminal face of each rod may be substantially perpendicular to the circumferential wall and, in different variants, it may be envisaged that this terminal face is substantially planar or bulging, or pointed, at the center thereof;
the rods are arranged in a matrix, whether this matrix be regular, with a constant spacing between two successive rods of a given alignment, or whether the rods be positioned in a staggered arrangement;

the height of a rod is between 1 and 10 micrometers; the largest dimension of the terminal face is smaller than 2 micrometers;
the distance that separates two immediately adjacent rods is equal to a minimum of 10 micrometers;
the size of the illuminating surface is at most 8 mm²;
the luminance obtained by the plurality of light-emitting rods is at least 60 Cd/mm², preferably at least 80 Cd/mm².

According to other features, it is possible to envisage that the semiconductor light source comprising a plurality of submillimeter-sized light-emitting rods additionally comprises a layer of a polymer material in which the rods are at least partially embedded; this polymer material may be based on silicon, it being understood that the polymer material is silicon based when a majority thereof is composed of silicon, e.g., at least 50% and in practice about 99%. The layer of polymer material may comprise a luminophore or a plurality of luminophores that are excited by the light generated by at least one of the plurality of rods. The term “luminophore”, or light converter, and e.g., a phosphorescent material, is understood to indicate the presence of at least one luminescent material designed to absorb at least a portion of at least one exciting light emitted by one light source and to convert a at least a portion of the absorbed exciting light to an emitted light with a wavelength that is different from that of the exciting light. This luminophore, or this plurality of luminophores, may be at least partially embedded in the polymer.

It is advantageous, according to the invention, that the two light sources have separate luminances. The term “luminance”, when referring to a light source, is understood to mean the total luminance of a source, obtained by considering the maximum light emitted by the totality of the light-emitting means, in particular the light-emitting rods, forming this light source. Thus, an adjusted light source is associated with the desired light function. In the case explained above, the provision of an area with luminance that is greater for the high beam than for the low beam is sought.

To this end, it may be envisaged that the two light sources are produced using a plurality of light-emitting diodes such as just described above. Each of the rods arises on at least one substrate, in particular made of silicon. Advantageously, it is possible to envisage that the substrate is shared by the two light sources, thereby allowing a single electrical interconnect to be provided to supply power to the electrodes associated with the semiconductor sources.

In each of these sources, as just explained, the distance that separates two immediately adjacent rods is, for example, equal to a minimum of 10 micrometers. Additionally, it is noteworthy that this distance of separation between two immediately adjacent rods may be the same between two rods of one and the same light source and between two rods of two adjacent light sources. This ensures thus that both light sources are produced contiguously, allowing a uniform high light beam to be produced when both light sources are switched on.

The light sources are controlled so as to be switched on separately and a system for controlling the separate switching on of these light sources is envisaged, it being understood that this principally means that the light sources may be switched on or off separately from one another, simultaneously or non-simultaneously. Additionally, it may be envisaged that two light-emitting rods or two groups of rods of one and the same light source are arranged so as to be switched on separately, it being understood that this means that one or more rods of one and the same light source may be controlled in order to vary the luminous intensity thereof.

Particularly in the case of two light sources employing light-emitting rods, it is possible to vary the illuminating surface of each of the two light sources by modifying the number of rods protruding from the substrate that are associated with one source or the other, or by modifying the number of mutually electrically connected rods.

According to the invention, the shaping optic may comprise an optic for projecting the light emitted by the semiconductor light source. This projection optic creates a real, and potentially anamorphosed, image of a portion of the device, e.g. the source itself or a shield, or of an intermediate image of the source, at a very large (finite or infinite) distance in front of the dimensions of the device (by a ratio of the order of at least 30, preferably 100) of the device. This projection optic may consist of one or more reflectors, or else of a lens, or even of a combination of these two possibilities.

According to the invention, the distance between two immediately adjacent rods is between 2 micrometers and 10 micrometers.

The luminous flux and luminance of a light source of the present invention are constrained by regulations on lighting and/or signaling in the automotive field and crosstalk between sticks. Furthermore, current electrical architectures in vehicles limit the power supply of the light source. Thus, to obtain an illumination and/or signalling beam in accordance with these regulations with such light source and the extent of these electrical architectures, the parameters of the light source of the invention as the height and diameter of the rods or in this case the spacing of the rods on the substrate of the light source can be varied. It has thus been found that the distance between two immediately adjacent rods should preferably be between 2 micrometers and 10 micrometers.

Moreover, this range allows easy manufacture of the shaping optic of which the resolving power will distinguish two separate groups of rods and will not allow to distinguish two separate rods.

The device is thus particularly suited for placement in the front headlamp of an automotive vehicle, being capable of emitting light according to a first lighting function, e.g. a low beam function, and a second lighting function, e.g. a high beam function.

These and other objects and advantages of the invention will be apparent from the following description, the accompanying drawings and the appended claims.

Other features and advantages of the present invention will become more clearly apparent with the aid of the description and the drawings, of which:

### BRIEF DESCRIPTION OF THE ACCOMPANYING DRAWINGS

FIG. 1 is a cross-sectional view of a lighting device according to the invention, in which light rays emitted by two semiconductor light sources have been illustrated, at least one of which semiconductor light sources comprises light-emitting rods, the rays being diverted by an optic for shaping the rays into two beams, each specific to one lighting function;

FIG. 2 is a schematic representation in perspective of a light-emitting device with two semiconductor light sources according to one embodiment of the invention, in which each light source comprises light-emitting rods;

FIG. 3 is a schematic representation in perspective of a light-emitting device with two semiconductor light sources, in which a row of light-emitting rods have been made visible in cross section;

FIG. 4 is a cross-sectional view of one particular embodiment of the invention, in which two light-emitting rods protrude from a substrate, the light-emitting rods being encapsulated in a protective layer;

FIGS. 5a and 5b are illustrations of the beams projected to infinity by the device of the invention, FIG. 5a illustrating a beam corresponding to the headlight of low beam type and FIG. 5b illustrating a beam corresponding to the headlight of high beam type;

FIG. 6 is a graph representing the luminance and the contrast of the light emitted by one semiconductor source of the light-emitting device in order to produce a headlight of low beam type; and

FIG. 7 is a graph representing the luminance of the light emitted by the light-emitting device when both semiconductor sources are activated in order to produce a headlight of high beam type.

### DETAILED DESCRIPTION OF THE PREFERRED EMBODIMENTS

A lighting device for an automotive vehicle comprises a light-emitting device 1, in particular housed in a housing closed by an outer lens and which defines an inner volume for accommodating the light-emitting device 1. The light-emitting device 1 is combined with an optic for shaping 2 at least a portion of the light rays emitted by the light-emitting device 1 via the output of the housing of the lighting device.

As explained above, the term “lighting device” covers an interior lighting device, an exterior lighting device or a signaling device. The example that will be described in more detail relates, in a non-limiting manner, to an exterior lighting function of the vehicle.

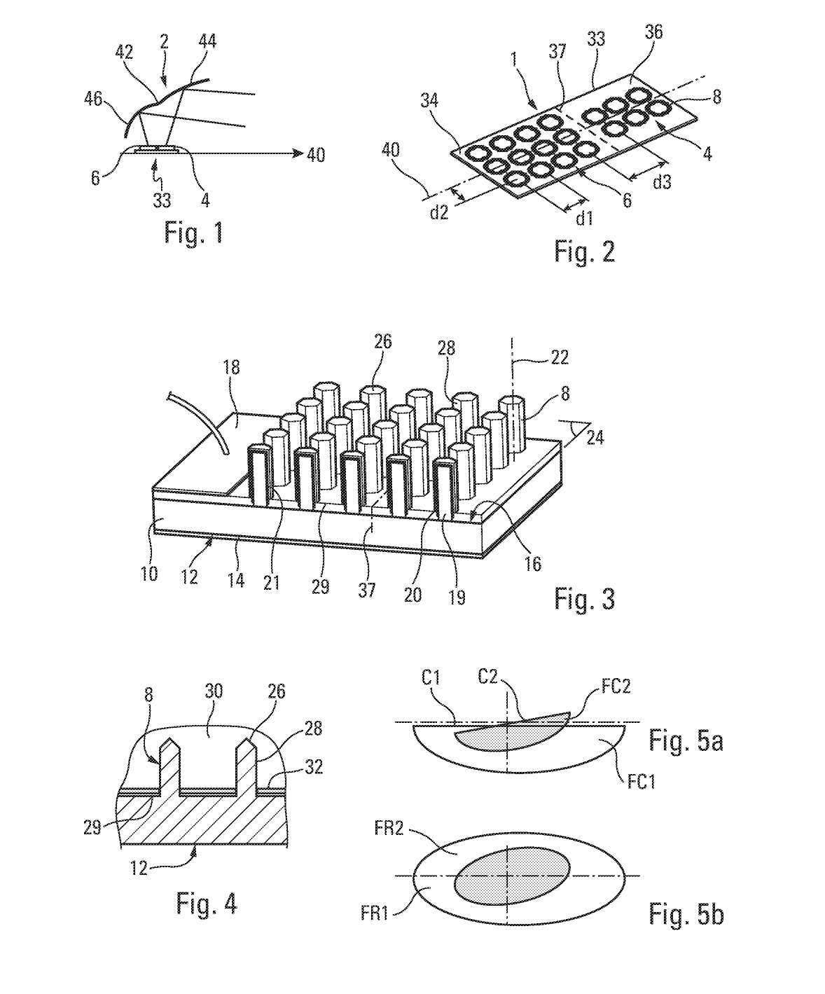

The light-emitting device 1 is, in this instance, arranged so as to form two separate light sources 4, 6, and, in particular, separate in that the luminance of a first light source 4 is higher than the luminance of the other one of the two light sources 6. At least one of these light sources 4, 6 is a semiconductor source, comprising submillimeter-sized light-emitting rods. According to different variant embodiments, it may be envisaged (as illustrated by way of example in FIG. 2) that the two light sources 4, 6 comprise submillimeter-sized light-emitting rods 8, i.e. three-dimensional semiconductor sources such as will be disclosed below, or else that (as illustrated by way of example in FIG. 1) only one of the semiconductor light sources 4 comprises submillimeter-sized light-emitting rods 8, while the other light source 6 is, for example, a light-emitting diode (LED), i.e. a two-dimensional semiconductor source that may be likened to a substantially planar source due to the planarity of the emissive layers. In a preferred variant, such as will be described below, the two light sources 4, 6 comprise light-emitting rods 8 and a substrate of these light-emitting rods 8 is shared by these two light sources 4, 6.

The structure of a semiconductor light source 4 comprising submillimeter-sized light-emitting rods 8 will now be described, referring in particular to FIGS. 3 and 4.

The light source 4 comprises a plurality of light-emitting rods 8 which arise on at least one substrate 10. Each light-emitting rod 8, formed, in this instance, using gallium nitride (Gₙ), protrudes perpendicularly, or substantially perpendicularly, from the substrate 10, based, in this instance, on silicon or silicon carbide. Other materials may be used without departing from the scope of the invention. By way of example, the light-emitting rods 8 could be made from a compound based on aluminum nitride and gallium nitride (AlₙGₙ), or from a compound based on aluminum, indium and gallium.

The substrate 10 has a bottom face 12, to which a first electrode 14 is added, and a top face 16, protruding from which are the light-emitting rods 8 and to which a second electrode 18 is added. Various layers of materials are superposed over the top face 16, in particular after the light-emitting rods 8 have been grown from the substrate 10, achieved, in this instance, using a bottom-up approach. Among these various layers, at least one layer of electrically conductive material may be found, in order to allow the light-emitting rods 8 to be supplied with electrical power. This layer is etched in such a way as to connect a given light-emitting rod 8 to another, the switching on of these light-emitting rods 8 then being able to be controlled simultaneously by a control module (not shown). It is possible to envisage that at least two light-emitting rods 8, or at least two groups of light-emitting rods 8, are arranged so as to be switched on separately, i.e. selectively, via a system for controlling the switching on thereof.

The light-emitting rods 8 stretch out from the substrate 10 and, as can be seen in FIG. 3, they each comprise a core 19 made of gallium nitride, around which quantum wells 20 are positioned, which quantum wells 20 are formed via a radial superposition of layers of various materials, in this instance gallium nitride and indium gallium nitride, and a shell 21 surrounding the quantum wells 20, which is also made of gallium nitride.

Each light-emitting rod 8 extends along a longitudinal axis 22 defining the height thereof, the base of each light-emitting rod 7 being positioned in a plane 24 of the top face 16 of the substrate 10.

The light-emitting rods 8 of one and the same light source 4, 6 advantageously take the same form. They are each delimited by a terminal face 26 and by a circumferential wall 28 that extends along the longitudinal axis 22. When the light-emitting rods 8 are doped and undergo polarization, the resulting light as output from the semiconductor source 4, 6 is essentially emitted from the circumferential wall 28, it being understood that the light rays may also exit from the terminal face 26. As a result, each light-emitting rod 8 acts as a single light-emitting diode and the density of the light-emitting rods 8 present for a light source 4 improves the luminous efficiency of this light source 4.

The circumferential wall 28 of a light-emitting rod 8, corresponding to the gallium nitride shell, is covered by a transparent conductive oxide (TCO) layer 29 that forms the anode of each light-emitting rod 8 which complements the cathode formed by the substrate 10. This circumferential wall 28 extends along the longitudinal axis 22 from the substrate 10 up to the terminal face 26, the distance from the terminal face 26 to the top face 16 of the substrate 10, from which the light-emitting rods 8 arise, defining the height of each light-emitting rod 8. By way of example, it is envisaged that the height of a light-emitting rod 8 is between 1 and 10 micrometers, while it is envisaged that the greatest transverse dimension of the terminal face 26, perpendicular to the longitudinal axis 22 of the light-emitting rod 8 in question, is smaller than 2 micrometers. It is also possible to envisage defining the area of a light-emitting rod 8, in a sectional plane perpendicular to this longitudinal axis 22, within a range of determined values, and in particular between 1.96 and 4 square micrometers.

It is understood that during the formation of the light-emitting rods 8, the height may be altered from one light source 4, 6 to the other, so as to increase the luminance of the light source 4, 6 when the height is increased. Thus, the height, or heights, of a group of light-emitting rods 8 may be different from that or those of another group of light-emitting rods 8, these two groups forming the same semiconductor light source 4, 6 comprising submillimeter-sized light-emitting rods 8.

The form of the light-emitting rods 8 may also vary from one device to the other, in particular in terms of the cross section of the light-emitting rods 8 and the form of the terminal face 26. FIGS. 1 and 2 illustrate light-emitting rods 8 with a circular cross section, and FIG. 3 illustrates light-emitting rods 8 taking a form with a polygonal, more particularly hexagonal, cross section. It is understood that the important point is that light may be emitted through the circumferential wall 28, whether this be polygonal or circular in form.

Additionally, the form of the terminal face 26 may be substantially planar and perpendicular to the circumferential wall 28, so that it extends substantially in parallel to the top face 16 of the substrate 10, as illustrated in FIG. 3, or else the form thereof may be bulging or pointed at the center thereof, in such a way as to multiply the directions of emission of the light exiting this terminal face 26, as illustrated in FIG. 4.

In FIGS. 2 and 3, the light-emitting rods 8 are arranged in a two-dimensional matrix. This arrangement could be such that the light-emitting rods 8 are in staggered rows. The invention covers other distributions of the light-emitting rods 8, particularly with densities of light-emitting rods 8 that may vary from one light source 4, 6 to the other, and which may vary according to different areas of one and the same light source 4, 6. FIG. 2 shows the distance that separates d1 two immediately adjacent light-emitting rods 8 in a first transverse direction and the distance that separates d2 two immediately adjacent light-emitting rods 8 in a second transverse direction. The distances of separation d1 and d2 are measured between two longitudinal axes 22 of adjacent columns. The number of light-emitting rods 8 protruding from the substrate 10 may vary from one device to the other, in particular for increasing the luminous density of the light source 4, 6, but it is recognized that one or the other of the distances of separation d1, d2 must be equal to a minimum of 10 micrometers, so that the light emitted by the circumferential wall 28 of each light-emitting rod 8 may exit the matrix of light-emitting rods 8.

The semiconductor light source 4 may furthermore comprise, as illustrated in FIG. 4, a layer 30 of a polymer material in which the light-emitting rods 8 are at least partially embedded. The layer 30 may thus extend over the entire expanse of the substrate 10 or only around a determined group of light-emitting rods 8. The polymer material, which may in particular be silicon based, creates a protective layer that allows the light-emitting rods 8 to be protected without disrupting the diffusion of light rays. Furthermore, it is possible to integrate wavelength-converting means, and e.g., luminophores, into this layer 30 of polymer material, which means are capable of absorbing at least a portion of the rays emitted by one of the light-emitting rods 8 and converting at least a portion of the absorbed exciting light to an emitted light with a wavelength that is different from that of the exciting light.

The light source 4, 6 may furthermore comprise a coating 32 of light-reflective material that is positioned between the light-emitting rods 8 in order to divert the rays which are initially oriented toward the substrate 10 toward the terminal face 26 of the light-emitting rods 8. Stated otherwise, the top face 16 of the substrate 10 may comprise a reflective means that reflects the light rays which are initially oriented toward the top face 16 toward the output face of the light source 4, 6. In this way, rays that otherwise would have been lost are recovered. This coating 32 is positioned between the light-emitting rods 8 on the transparent conductive oxide layer 29.

A lighting or light-emitting device 1 comprising an emitter device will now be described, which emitter device is formed from two semiconductor light sources 4, 6 comprising light-emitting rods 8 and an optic for shaping 2 the light emitted by either or both light sources 4, 6 with the aim of generating at least two lighting and/or signaling functions.

The light-emitting device 1 comprises, in this instance, a rectangular form, but it will be understood that it may take other general forms without departing from the scope of the invention, in particular a parallelogrammic form.

In FIGS. 2 and 3, the light-emitting device 1 has an emissive portion 33 divided into two contiguous areas, namely a first area 34 and a second area 36, these two areas 34, 36 being positioned in series along the optical axis 40 defined by the emissive device and the shaping optic. The first area 34 is positioned in front of the second area 36 with respect to the optical axis 40 and the main direction of emission of rays, i.e. the location thereof on the optical axis 40, with respect to the second area 36, is closer to the output of the lighting device. The separation 37 between the two areas 34, 36 follows, in this instance, the form of a straight portion. As will be described in more detail below, this separation 37 may be achieved by physically making a wall protruding from the substrate 10, but it is first and foremost made by the determined wiring of a given light-emitting rod 8 to another.

In each of these areas 34, 36, a semiconductor light source 4, 6 with submillimeter-sized light-emitting rods 8 is positioned on each side of the separation 37, these two semiconductor light sources 4, 6 being electrically connected so as to be selectively activatable. FIG. 2 shows the distance of separation d3, in the first transverse direction, between a light-emitting rod 8 of a first semiconductor light source 4 and a directly adjacent light-emitting rod 8 and a second semiconductor light source 6. It is recognized that this distance of separation d3, measured between two longitudinal axes 22 of light-emitting rods 8, must be equal to a minimum of 10 micrometers, so that the light emitted by the circumferential wall 28 of each light-emitting rod 8 may exit the matrix of light-emitting rods 8, and a distance of separation d3 between two light-emitting rods 8 of two different light sources 4, 6 that is substantially equal to the distance of separation d1 or d2 of two light-emitting rods 8 of one and the same light source 4, 6 is sought.

It is advantageous to envisage that the two semiconductor light sources 4, 6 have separate luminances, in particular in the context of application to a “dual-function” device, i.e. a device capable of carrying out two separate lighting functions. In the following description, a preferred application in which the device may carry out a first lighting function of low beam type and a second lighting function of high beam type is more particularly considered. Multiple distinctions may be drawn between the two areas 34, 36 of the emissive surface, associated, respectively, with one or the other of the lighting functions, it being understood that in this application, it is desired that the activation of the first semiconductor light source 4 positioned in the first area 34 allows the first lighting function to be carried out, i.e. the emission of a low beam, which therefore requires reduced luminance but high flux, while the activation of the second semiconductor light source 6 allows the second lighting function to be carried out, i.e. the emission of a high beam, which therefore requires high luminance, but with reduced flux. It is possible to envisage, without departing from the scope of the invention, that the second lighting function is carried out only by activating the second semiconductor light source 6, while the first semiconductor light source 4 is switched off, or else that this second lighting function is carried out by simultaneously activating the first and second semiconductor light sources 4, 6, the activation of the second semiconductor light source 6 generating a beam that is complementary to the beam formed by the first semiconductor light source 4 in order to produce the beam of high beam type by combination.

In FIG. 2, the two emissive areas 34, 36 are not of the same size and they do not have the same number of submillimeter-sized light-emitting rods 8. Preferably, the first area 34 is larger than the second area 36, in the direction of the optical axis 40 defined above, by a ratio of substantially one to two.

The density of the submillimeter-sized light-emitting rods 8 in each of the semiconductor sources 4, 6 is advantageously different. It is possible to envisage a different, or substantially different, distribution of light-emitting rods 8 in each of the areas 34, 36, or else an identical, or substantially identical, distribution of light-emitting rods 8 in each of the areas 34, 36, the light-emitting rods 8 in this case possibly being electrically connected in their entirety or not according to one light source 4, 6 or the other. A greater density of light-emitting rods 8 for the second area 36, associated with the second light source 6, is advantageously envisaged, which light source 6 is only switched on when a lighting function of high beam type is required.

The height of the light-emitting rods 8 from one light source 4, 6 to the other is also advantageously different. The light-emitting surface is thus modified by increasing the height of the circumferential wall 28 and the luminance of the second light source 6 with respect to the first light source 4 is increased by increasing the height of at least one of the submillimeter-sized light-emitting rods 8 in the first area 34 bearing the first light source 4.

It is understood that it is possible to choose between either of these options in order to envisage a second light source 6 whose luminance is higher than the luminance of the first light source 4, or else that they could both be used, it being understood that other means for varying the luminance could be used.

In FIG. 3, the substrate 10 is shared by the two nanowire semiconductor light sources 4, 6. The number of electrical connection wires is thus optimized, and the bringing together of the two light sources 4, 6 is facilitated, the contiguous character of this arrangement being particularly advantageous for obtaining a uniform flux when the two semiconductor light sources 4, 6 are activated simultaneously.

The optic for shaping 2 the light rays consists, in the illustrated example, of a reflector 42 that has two separate areas 44 and 46, each being capable of receiving the light arising from the two separate areas 34, 36 of the emissive portion. The first area 44 of the reflector 42 receives the rays emitted by the first area 34 of the emissive portion in order to form, via the output of the lighting device, a first beam and the second area 46 of the reflector 42 receives the rays emitted by the second area 36 of the emissive portion in order to form, via the output of the lighting device, a second beam. It is understood that this distribution is theoretical and it must be envisaged that, in reality, the first area 44 of the reflector 42 also contributes to the reflection of the rays emitted by the second area 36 of the emissive portion and, conversely, that the second area 46 of the reflector 42 also contributes to the reflection of the rays emitted by the first area 34 of the emissive portion. In a variant, it is, for example, one and the same single area that is illuminated by the two areas 34 and 36, but with, for example, the first area 34 being focused and the second area 36 being defocused.

The two areas 34, 36 of the emissive portion can be activated selectively of one another. It is particularly possible to envisage that the second area 36, when it is activated, emits rays that form, after having been reflected by the projection means, a second beam which is complementary to the first beam projected by the projection means when the second area 36 of the emissive portion is activated. The term “complementary beam” is understood to mean a beam that forms, with the beam produced by the first semiconductor light source 4, a coherent beam when the two sources 4, 6 are controlled so as to simultaneously carry out the emission of the light beam that is specific thereto. These two complementary beams are superposed in order to form a light beam for an automotive vehicle that conforms to regulations, e.g., a low/high beam formed by a “low” area and a “high” area or e.g., a low beam formed by a first “low” area and a second “low” area.

As explained above, the case in which the first area 34 of the emissive portion corresponds to a “low” area (ZC) while the second area 36 of the emissive portion corresponds to a “high” area (ZR) will be more particularly described. The two areas 34, 36 of the emissive portion can be activated selectively of one another and it is envisaged to activate only the first area 34, referred to as the “low” area, in order to form a headlight corresponding to low beam headlight, i.e. a dipped beam headlight that is suitable for not dazzling the occupants of another vehicle (the beam that can be seen in FIG. 4), and to activate both areas 34, 36, that referred to as the “low” area and that referred to as the “high” area, in order to form a headlight of high beam, or main beam, type. It is understood that a single semiconductor light source 4 generates light rays contributing to the formation of a dipped beam headlight, while the two semiconductor light sources 4, 6 together generate light rays contributing to the formation of a high beam headlight. It is also possible to envisage, as described above, that one semiconductor light source 4 or 6 is strictly associated with a first lighting function and that the other semiconductor light source 4 or 6 is strictly associated with a second lighting function.

As illustrated in FIG. 5a, when the first area 34 of the emissive portion is activated alone, the first area 44 of the reflector 42 produces a first sub-beam FC1 that has a flat horizontal cutoff c1 while the second area 46 of the reflector 42 produces a second sub-beam FC2 that has a flat oblique cutoff c2. The beams FC1 and FC2 are superposed in order to form the beam corresponding to the headlight of low beam type. It may be envisaged that the cutoffs c1 and c2 form an angle between them that is between 10 and 60 degrees, preferably between 15 and 45 degrees.

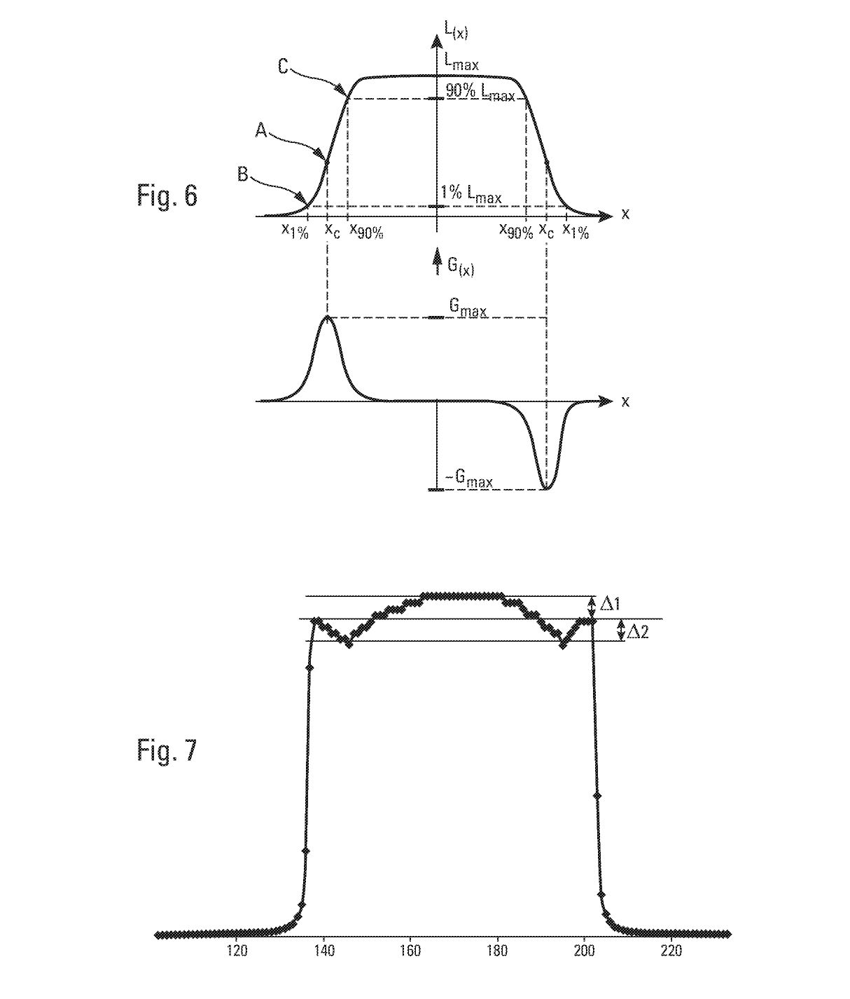

So that the low beam conforms to regulations, the cutoff must have sufficient contrast. FIG. 6 illustrates a luminance map representing the light emitted by the “low” area and a representation of the contrast values G(x) that are defined by the function:

G(x)=Log10[L(x)]−Log10[L(x+step)].

The aim is that a value of the difference between the maximum contrast (point A) and the level of 1% of the maximum luminance (point B) does not exceed 0.2 mm and, preferably, it must not exceed 0.1 mm.

Additionally, in order to guarantee a good illumination range in low beam, the maximum intensity in low beam must be placed as close possible below the cutoff, which, on the luminance map of FIG. 6, translates into a maximum distance of 0.03 mm between the maximum contrast (point A) and the level of 90% of the maximum luminance (point C), it being understood that the model is for the case of Lam bertian-type emitters.

As illustrated in FIG. 5b, when the two areas of the emissive portion are simultaneously supplied with power, the area 44 of the reflector forms a wide and uniform beam FR1 that may be likened to the beam illustrated in FIG. 5a, and the area 46 of the reflector forms a concentrated and uniform beam FR2 that is superposed over the first.

It is understood that the separation between the first area 34 and the second area 36 of the light-emitting device 1 is non-emissive, the separation possibly being formed by an opaque wall protruding from the substrate 10 between the light-emitting rods 8 that are positioned on the border of each area 34, 36. This separation creates, in the high beam obtained via the combined emission of both areas 34, 36 of the emissive portion, an area that is darkened with respect to the rest. In order for the high beam to be as uniform as possible, it is important that this darkened area be reduced to a minimum, i.e. that the areas 34, 36 be as contiguous as possible. On a luminance map such as illustrated in FIG. 6 and representing the light emitted when both areas 34, 36 are activated simultaneously, this translates into a difference of less than 10% with respect to the mean maximum luminance, over a range in which the luminance is greater than 90%, it being understood that, in this instance as well, the model is for the case of Lambertian-type emitters. FIG. 7 is a graph representing the luminance of the light emitted by the light-emitting device when both semiconductor sources are activated in order to produce a headlight of high beam type.

The present invention is most particularly applicable to a front headlamp of an automotive vehicle.

The preceding description clearly explains how the invention allows the set objectives to be achieved, and in particular proposes a lighting device that allows dual-function lighting, i.e. differing lighting with a single shaping optic, to be produced at low cost and without loss of photometric quality. It is understood that an application to a dual-function device allowing lighting of low beam type and high beam type to be produced has more particularly been described, but that the device could easily be applied in order to carry out different functions, possibly including, in particular, a daytime running light function.

Of course, various modifications may be added to the structure of the lighting device, described above by way of non-limiting example, by a person skilled in the art, as long as it uses at least one semiconductor light source with light-emitting rods, in particular in order to easily vary the luminance from one source to the other. In any event, the invention is not limited to the embodiment specifically described in this document, and extends in particular to any equivalent means and to any technically workable combination of these means.

By way of example, certain variants that are not represented are described below, although this list is not exhaustive:
the optic for shaping the light rays does not consist of a reflector as described above, but rather consists of at least one lens or of a combination of reflector(s) and lens(es);
the dimensions of the two areas of the emissive portion are substantially equal, it being understood that like above, the rays emitted separately by the first and second areas are diverted by the shaping optic in order to produce two separate lighting and/or signaling beams.

While the system, apparatus, process and method herein described constitute preferred embodiments of this invention, it is to be understood that the invention is not limited to this precise system, apparatus, process and method, and that changes may be made therein without departing from the scope of the invention which is defined in the appended claims.

What is claimed is:

1. A lighting device for an automotive vehicle, comprising at least a first semiconductor light source and a second semiconductor light source that can be selectively activated and at least one optic for shaping the light emitted by either or both of said first semiconductor light source and said second semiconductor light source with the aim of generating at least two lighting and/or signaling functions, said lightning device being configured so that a first lighting and/or signaling function requires an activation of said first semiconductor light source and a second lighting and/or signaling function requires an activation of said second semiconductor light source, at least said second semiconductor light source comprising a plurality of light-emitting rods of submillimeter size.

2. The lighting device according to claim 1, wherein said second lighting and/or signaling function solely requires said activation of said second semiconductor light source.

3. The lighting device according to claim 2, wherein said lighting and/or signaling function generates the formation of a light beam of fog beam type.

4. The lighting device according to claim 2, wherein said second lighting and/or signaling function generates the formation of a light beam of low beam type.

5. The lighting device according to claim 1, wherein said second lighting and/or signaling function requires the simultaneous activation of said first semiconductor light source and said second semiconductor light source.

6. The lighting device according to claim 5, wherein said second lighting and/or signaling function generates the formation of a light beam of high beam type.

7. The lighting device according to claim 6, wherein said generates the formation of a light beam of low beam type.

8. The lighting device according to claim 1, wherein said plurality of light-emitting rods are on a same substrate.

9. The lighting device according to claim 1, wherein said plurality of light-emitting rods take the general form of a cylinder, in particular with a polygonal cross section.

10. The lighting device according to claim 1, wherein a height of said plurality of light-emitting rods is between 1 and 10 micrometers.

11. The lighting device according to claim 1, wherein said plurality of light-emitting rods are each delimited by a terminal face and a circumferential wall that extends along a longitudinal axis of said plurality of light-emitting rods, defining a height thereof, the light being emitted at least from said circumferential wall.

12. The lighting device according to claim 11, wherein said wherein a largest dimension of said terminal face is smaller than 10 micrometers, preferably smaller than 5 micrometers.

13. The lighting device according to claim 1, wherein said first semiconductor light source and said second semiconductor light source have separate luminances.

14. The lighting device according to claim 1, wherein a distance (d1, d2, d3) that separates two immediately adjacent light-emitting rods is equal to a minimum of 2 micrometers and a maximum of 100 micrometers.

15. The lighting device according to claim 14, wherein said a distance (d3) that separates said two immediately adjacent light-emitting rods of two adjacent light sources is equal to said distance (d1, d2) that separates said two immediately adjacent light-emitting rods of the same light source.

16. The lighting device according to claim 2, wherein said plurality of light-emitting rods are on a same substrate.

17. The lighting device according to claim 2, wherein said plurality of light-emitting rods take the general form of a cylinder, in particular with a polygonal cross section.

18. The lighting device according to claim 2, wherein a height of said plurality of light-emitting rods is between 1 and 10 micrometers.

19. The lighting device according to claim 2, wherein said plurality of light-emitting rods are each delimited by a terminal face and a circumferential wall that extends along a longitudinal axis of said plurality of light-emitting rods, defining a height thereof, the light being emitted at least from said circumferential wall.

20. The lighting device according to claim 2, wherein said first semiconductor light source and said second semiconductor light source have separate luminances.
